(19) United States
(12) Patent Application Publication
(10) Pub. No.: US 2008/0092074 A1
(43) Pub. Date: Apr. 17, 2008

(54) ASCRIBING VISUAL METADATA TO WORKFLOW COMPONENTS MODELED USING GRAPHICAL ICONS

(75) Inventor: Gabriel Aaron Cohen, Durham, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/550,097

(22) Filed: Oct. 17, 2006

(51) Int. Cl. G06F 3/048

(52) U.S. Cl. 715/771

(57) ABSTRACT

Visual metadata is ascribed to workflow components that are modeled using graphical icons. The visual metadata includes instructions for displaying a graphical icon in a predetermined left-right or up-down orientation, displaying a graphical icon in one of a plurality of predetermined sizes, embedding customized anchor points within a graphical icon for wiring the graphical icon into a logical workflow view, identifying a data type for a workflow component, identifying shape, size, or orientation for the customized anchor points, embedding customized anchor points for individual data elements within a graphical icon so as to provide data wiring associated with visual targets within the workflow component, or various combinations thereof. The visual metadata is bound to the component, or the visual metadata is retrieved by providing a workflow tool with identifying indicia for the component. If a component is incorporated into a workflow, data mapping tool, or data flow, the visual metadata is used to determine an iconic representation for the graphical icon in the workflow, and also to render any embedded anchor points included in the visual metadata.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The present invention relates generally to the field of graphical icons. More specifically, the present invention ascribes visual metadata to workflow components modeled using graphical icons.

2. Description of Background

A number of presently existing workflow tools allow users to graphically assemble composite applications from preexisting workflow components. These composite applications are assembled, for example, by manipulating workflow component layout and wiring. Each workflow component may represent an individual step or process in a workflow. Typically, the visual representation of a component in a workflow is based on an overall theme where a graphical icon is indicative of the type or category of a component. A label, or other property associated with the graphical icon, provides detail regarding a particular instance of that type of component. For example, one existing workflow tool, known as IBM Websphere Business Integration Server Foundation Process Choreographer or WBI Process Choreographer, represents all web service invocations using named “invoke” icons in the sequence or process being developed. When workflow processes are developed in this manner, it is difficult to visualize information about each of the workflow components included in a process. To visualize such information, a user is required to interact with the workflow tool to retrieve properties of instances of a specific step type. Accordingly, existing workflow tools provide very limited information describing the action or actions to be performed at each workflow step. What is needed is an improved workflow tool methodology which provides visually descriptive information relating to each of a plurality of workflow components.

### SUMMARY OF THE INVENTION

The shortcomings of the prior art are overcome and additional advantages are provided by ascribing visual metadata to workflow components modeled using graphical icons. The visual metadata includes instructions for one or more of: displaying a graphical icon in a predetermined left-right or up-down orientation or both; displaying a graphical icon in one of a plurality of predetermined sizes; embedding one or more customized anchor points within a graphical icon for wiring the graphical icon into a logical workflow view; identifying a data type for a workflow component; embedding one or more customized anchor points for individual data elements within a graphical icon so as to provide data wiring associated with one or more visual targets within the workflow component; or identifying at least one of shape, size, or orientation for the customized anchor points. The visual metadata is bound to the workflow component, or the visual metadata is retrieved by providing a workflow tool with identifying indicia for the workflow component. If a workflow component is incorporated into a workflow, data mapping tool, or data flow, the visual metadata is used to determine an iconic representation for the graphical icon in the workflow, and also to render any embedded anchor points included in the visual metadata.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution wherein ascribing visual metadata to workflow components provides visually descriptive information relating to each of a plurality of workflow components included in a workflow, thereby enhancing the visual experience of a workflow tool user and facilitating development of the workflow.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary method for modeling workflow components using graphical icons.

FIG. 2 illustrates an exemplary workflow to which the method of FIG. 1 may be applied.

Like reference numerals are used to refer to like elements throughout the drawings. The detailed description explains the preferred embodiments of the invention, together with advantages and features, by way of example with reference to the drawings.

### DETAILED DESCRIPTION OF THE INVENTION

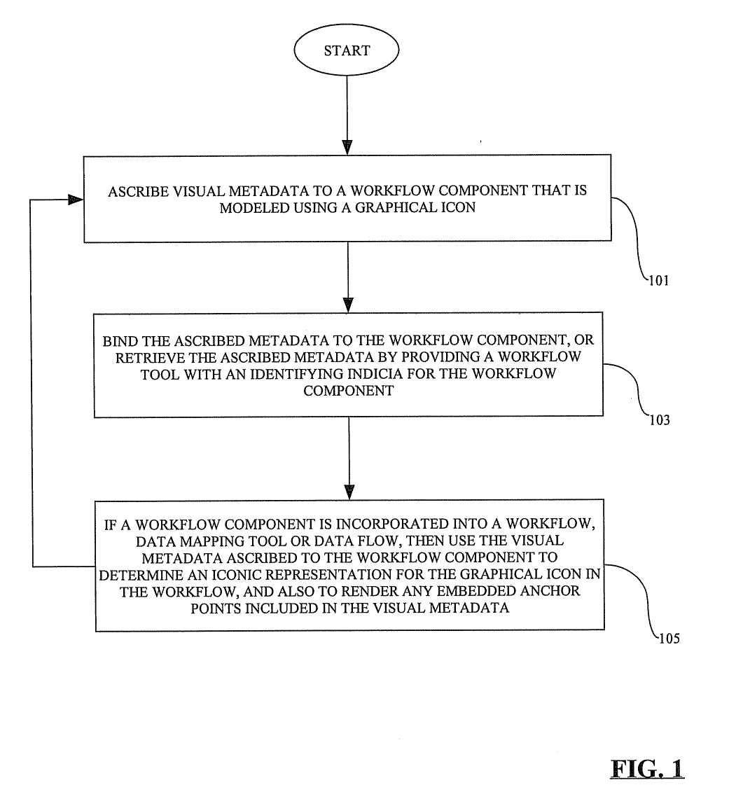

FIG. 1 illustrates an exemplary method for modeling workflow components using graphical icons. The process commences at block 101 where visual metadata is ascribed to a workflow component modeled using a graphical icon. The visual metadata includes instructions for one or more of: displaying a graphical icon in a predetermined left-right or up-down orientation or both; displaying a graphical icon in one of a plurality of predetermined sizes; embedding one or more customized anchor points within a graphical icon for wiring the graphical icon into a logical workflow view; identifying a data type for a workflow component; embedding one or more customized anchor points for individual data elements within a graphical icon so as to provide data wiring with one or more visual targets within the workflow component; or identifying at least one of shape, size, or orientation for the customized anchor points.

Next, at block 103, the visual metadata ascribed to a workflow component is bound to the workflow component, or the visual metadata ascribed to a workflow component is retrieved by providing a workflow tool with an identifying indicia (such as a definition) for the workflow component. At block 105, if a workflow component is incorporated into a workflow, data mapping tool, or data flow, the visual metadata ascribed to the workflow component is used to determine an iconic representation for the graphical icon in the workflow, and also to render any embedded anchor points included in the visual metadata.

The method of FIG. 1 enables graphical icons developed by third parties to be incorporated into a workflow tool. Optionally, the workflow tool may provide functionality such as execution path wiring or data mapping or both. The method of FIG. 1 enables use of third-party graphical icons in a workflow while, at the same time, satisfying any workflow tool requirements relating to execution path wiring and data mapping.

Metadata may, but need not, be ascribed to workflow components by means of schema-defined extensible markup language (XML) code. Illustratively, such XML code could be included in a web services description language (WSDL) document, and may be included in one or more app-info sections of the document. WSDL is an XML-based language used to describe the services a business offers, and also to provide a mechanism for individuals and other businesses to access these services electronically. WSDL is part of an industry initiative known as universal description, discovery, and integration (UDDI) being developed by IBM, Microsoft, and Ariba. UDDI is an XML-based registry for businesses worldwide, enabling businesses to list themselves and their services on the Internet. WSDL is the language many businesses are adopting to provide such listings. WSDL is derived from Microsoft's Simple Object Access Protocol (SOAP) and IBM's Network Accessible Service Specification Language (NASSL). WSDL replaces both NASSL and SOAP as a means of expressing business services in a UDDI registry.

If schema-defined XML code is used to ascribe metadata to workflow components, the term “schema” as used herein refers to an organization or structure for a database. Schema is derived from the Greek word for “form” or “figure”. The activity of data modeling leads to a schema. Schemas are used in relational databases as well as object-oriented databases. The term may refer to a visualization of a structure, or to a formal text-oriented description, or both.

Ascribing metadata to workflow components as described herein does not affect any existing web service standards. For data views, app-info with information about the images and anchor point maps can be embedded in “type” declarations in the WSDL itself, or in referenced schema. Additionally, a technology such as web services for remote portlets (WSRP), which is a standard mechanism for embedding HTML interfaces in web service definitions, could be used to generate the appearance of a service in a workflow. WSRP may be used to provide dynamic plug-ins for portal pages. Officially ratified as a standard in September 2003, WSRP defines techniques for plugging remote web services into the pages of online portals and other user-facing applications. This allows portal or application owners to easily embed a web service from a third party into a section of a portal page (a ‘portlet’). The portlet then displays interactive content and services that are dynamically updated from the provider's own servers. Formerly known as Web Services for Remote Portals, WSRP is closely allied with WSIA (Web Services Interactive Applications). A separate Java standard for portlets is known as JSR 168.

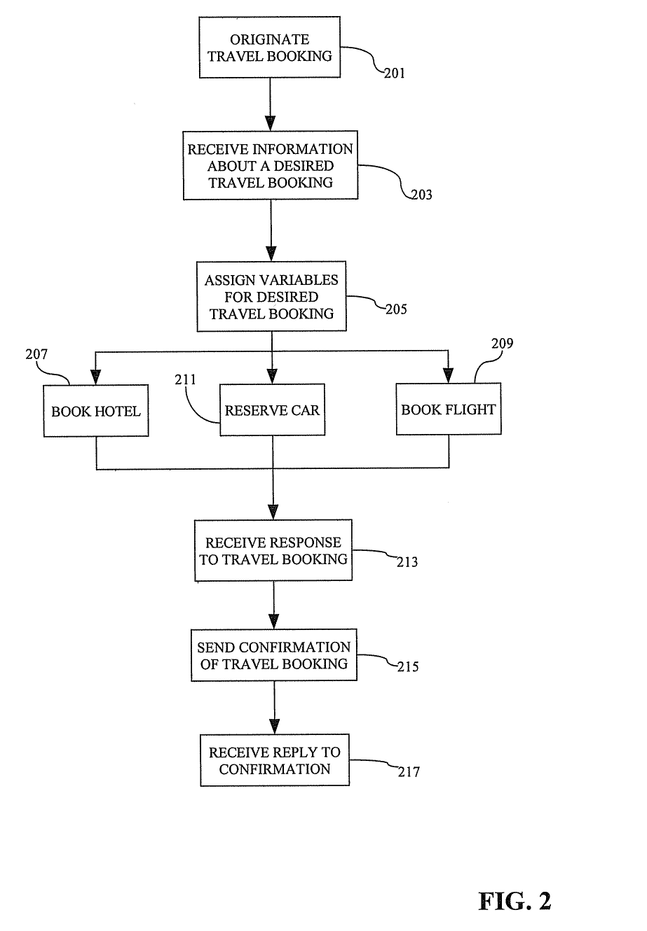

FIG. 2 illustrates an exemplary workflow to which the method of FIG. 1 may be applied. The workflow commences at block 201 where a travel booking is originated. At block 203, information is received about a desired travel booking. Variables for the desired travel booking are assigned at block 205. Next, a hotel may be booked (block 207), or a car may be reserved (block 209), or a flight may be booked (block 211). Blocks 207, 209, and 211 may be performed in any order, contemporaneously, or simultaneously. Moreover, it is not necessary to perform all three of these blocks 207, 209, 211 so long as at least one of blocks 207, 209, or 211 is performed. Next, at block 213, a response to the hotel, car, and/or flight booking is received. A confirmation of the travel booking is sent at block 215, and a reply to the confirmation is received at block 217.

In the workflow example of FIG. 2, note that the actions of blocks 207, 209, and 211 (booking a hotel, reserving a car, and booking a flight) may occur in parallel. In each of these actions, a specific vendor might be used to provide the corresponding service. For example, Marriott Hotels may be used to book a hotel, Hertz may be used to reserve a car, and American Airlines may be used for booking a flight. However, prior art workflow tools do not include information about the specific service provider in the workflow visualization. Imagine that Marriott wants to expand its branding of services. Accordingly, Marriott embeds a desired logo or image into a description of its web reservation service. A workflow tool enhanced as described in connection with FIG. 1, when using the Marriott Hotels reservation service, would embed the logo or image provided by Marriott into a graphical icon depicted generically in FIG. 2 as block 207. Additional metadata provided by Marriott with its reservation service may specify one or more anchor point locations on this graphical icon for wiring the icon in and out of a workflow action that invokes the reservation service.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of modeling workflow components using graphical icons, the method comprising:
ascribing visual metadata to a workflow component, wherein the visual metadata includes instructions for one or more of: displaying a graphical icon in a predetermined left-right or up-down orientation or both; displaying a graphical icon in one of a plurality of predetermined sizes; embedding one or more customized anchor points within a graphical icon for wiring the graphical icon into a logical workflow view; identifying a data type for a workflow component; embedding one or more customized anchor points for individual data elements within a graphical icon so as to provide data wiring associated with one or more visual targets within the workflow component; or identifying at least one of shape, size, or orientation for the customized anchor points;
binding the ascribed visual metadata to the workflow component, or retrieving the ascribed visual metadata by providing a workflow tool with identifying indicia for the workflow component; and
if the workflow component is incorporated into a workflow, data mapping tool, or data flow, using the ascribed visual metadata to determine an iconic representation for the graphical icon in the workflow, and also to render any embedded anchor points included in the visual metadata.

2. The method of claim 1 wherein ascribing visual metadata to a workflow component is performed using extensible markup language (XML) code.

3. The method of claim 2 wherein the XML code is schema-defined, schema referring to an organization or a structure for a database.

4. The method of claim 2 wherein the XML code is included in a web services description (WSDL) document.

5. The method of claim 1 further including the step of using web services for remote portlets (WSRP) to embed a hypertext markup language (HTML) interface into a web service definition to thereby generate an appearance of a web service in a workflow.

6. A computer program product for modeling workflow component using graphical icons, the computer program product comprising a storage medium readable by a processing circuit and storing instructions for execution by the processing circuit for facilitating a method comprising:
ascribing visual metadata to a workflow component, wherein the visual metadata includes instructions for one or more of: displaying a graphical icon in a predetermined left-right or up-down orientation or both; displaying a graphical icon in one of a plurality of predetermined sizes; embedding one or more customized anchor points within a graphical icon for wiring the graphical icon into a logical workflow view; identifying a data type for a workflow component; embedding one or more customized anchor points for individual data elements within a graphical icon so as to provide data wiring associated with one or more visual targets within the workflow component; or identifying at least one of shape, size, or orientation for the customized anchor points;
binding the ascribed visual metadata to the workflow component, or retrieving the ascribed visual metadata by providing a workflow tool with identifying indicia for the workflow component; and
if the workflow component is incorporated into a workflow, data mapping tool, or data flow, using the ascribed visual metadata to determine an iconic representation for the graphical icon in the workflow, and also to render any embedded anchor points included in the visual metadata.

7. The computer program product of claim 6 further including instructions for ascribing visual metadata to a workflow component using extensible markup language (XML) code.

8. The computer program product of claim 7 wherein the XML code is schema-defined, schema referring to an organization or a structure for a database.

9. The computer program product of claim 2 wherein the XML code is included in a web services description (WSDL) document.

10. The computer program product of claim 6 further including instructions for using web services for remote portlets (WSRP) to embed a hypertext markup language (HTML) interface into a web service definition to thereby generate an appearance of a web service in a workflow.
